(19) United States
(12) Patent Application Publication
(10) Pub. No.: US 2015/0309814 A1
(43) Pub. Date: Oct. 29, 2015

(54) APPARATUS AND METHOD FOR VIRTUAL HOME SERVICE

(71) Applicant: Electronics and Telecommunications Research Institute, Daejeon (KR)

(72) Inventors: Deock-Gu JEE, Daejeon (KR); Eun-Jin KO, Daejeon (KR); Ji-Yeon KIM, Daejeon (KR); Jong-Hyun JANG, Daejeon (KR)

(21) Appl. No.: 14/677,433

(22) Filed: Apr. 2, 2015

(30) Foreign Application Priority Data
Apr. 24, 2014 (KR) 10-2014-0049262

(51) Int. Cl. G06F 9/455

(52) U.S. Cl. CPC G06F 9/455

(57) ABSTRACT

The present invention provide an apparatus and method for virtual home service. The virtual home service apparatus comprises a physical device registration unit registering or deleting physical devices present in home and controlling the registered physical devices; a virtual device generation unit generating virtual devices using the registered physical device; a context reasoning unit reasoning in-home context using information of the generated virtual devices; and a service control unit generating a virtual device control command according to the result of the reasoned in-home context and delivering the result to the virtual device generation unit, wherein the virtual device generation unit generates hybrid virtual devices comprising a plurality of physical devices according to input of a user's virtual device generation command including physical device configuration information of the hybrid virtual devices or generates a single virtual device corresponding one-to-one to the physical device according to input of profile information of the physical device.

### CROSS REFERENCE TO RELATED APPLICATION

This application claims the benefit of Korean Patent Application No. 10-2014-0049262, filed on Apr. 24, 2014, entitled “Apparatus and method for virtual home service”, which is hereby incorporated by reference in its entirety into this application.

### BACKGROUND OF THE INVENTION

1. Technical Field

The present invention relates to a home network technology and more particularly, to an apparatus and method for virtual home service.

2. Description of the Related Art

In a smart home system combining a home network technology and a context recognition technology, home appliances and sensors are connected to a home network server to collect a variety of in-home information, recognize context using the collected data and provide services corresponding to the recognized context. Thus, such a system is applied to various fields such as medical/healthcare, energy management, security and the like. Currently, the smart home system has been combined with a metaverse technology to represent whole information of in-home users and sensors, home appliances and the like on a virtual space in-real time and provide virtual home services by reflecting the operation of devices of a virtual world to a real world.

The smart home system requires to install a plurality of sensors in home and recognizes context through extraction, learning, reasoning and the like of context information using data collected from a plurality of home appliances in order to provide services by recognizing various contexts relating to medical/healthcare, energy management, security and the like exactly. However, there are some drawbacks since there is limitation to recognize exact context including recognition of user intention and it needs involvement of a user to provide user-specific services.

In implementation of a virtual home for a user to be provided with services by connecting to a virtual home server, physical devices present in home and virtual devices are mapped one-to-one to be represented in virtual home or represented according to a predetermined method in virtual home. However, implementation of virtual home by one-to-one mapping causes inconvenience to a user.

### SUMMARY OF THE INVENTION

The present invention is to provide a smart home system combined a home network technology with a context recognition technology on a virtual space.

The present invention is also to provide user-specific virtual home services by generating virtual devices corresponding to a plurality of actual in-home physical devices by reflecting user's intention.

According to an aspect of the present invention, there is provided a virtual home service apparatus.

The virtual home service apparatus according to an embodiment of the present invention comprises a physical device registration unit registering or deleting physical devices present in home and controlling the registered physical devices; a virtual device generation unit generating virtual devices using the registered physical devices; a context reasoning unit reasoning in-home context using information of the generated virtual devices; and a service control unit generating a virtual device control command according to the result of the reasoned in-home context and delivering the result to the virtual device generation unit, wherein the virtual device generation unit generates hybrid virtual devices comprising a plurality of physical devices according to input of a user's virtual device generation command including physical device configuration information of the hybrid virtual devices or generates a single virtual device corresponding one-to-one to the physical device according to input of profile information of the physical device.

The physical device comprises a sensor device comprising at least one of an IR sensor, a smoke sensor, a temperature sensor and a gas sensor; and an in-home device comprising at least one of a microphone, a closed circuit TV(CCTV), a refrigerator, a TV, a washing machine, a heater and a gas valve circuit breaker.

The physical device registration unit transmits sensing information or state information received from the physical device to the virtual device generation unit, and generates, when a physical device control command is received from the virtual device generation unit, control data for a corresponding physical device and transmits the result to the corresponding physical device.

The virtual device generation unit generates a single virtual device corresponding one-to-one to the physical device by receiving profile information of the physical device from the physical device registration unit to or generates a ID-assigned hybrid virtual device according to input of a user's virtual device generation command including physical device configuration information of the hybrid virtual device.

The virtual device generation unit generates a single virtual device corresponding one-to-one to the physical device, a hybrid virtual device composed with a plurality of physical devices, a hybrid virtual device composed with a plurality of virtual devices or a hybrid virtual device composed with physical devices and virtual devices.

The virtual device generation unit, when sensing information or state information received from the physical device is received from the physical device registration unit, transmits the received sensing information or state information as virtual device information corresponding to the physical device to the context reasoning unit, and transmits, when the virtual device control command is received from the service control unit, a physical device control command for the corresponding physical device to the physical device registration unit.

According to another aspect of the present invention, there is provided a virtual home service method from a virtual home service apparatus.

A virtual home service method according to an embodiment of the present invention comprises: being inputted with a user's virtual device generation command comprising physical device configuration information of hybrid virtual devices; generating the hybrid virtual device comprising a plurality of physical devices by analyzing the virtual device generation command; generating a single virtual device corresponding one-to-one to the physical device when the virtual device generation command is not inputted but profile information of physical devices is; reasoning in-home context using virtual device information according to the generation of the virtual device; and controlling a virtual home service by generating a virtual device control command according to the result from the reasoning in-home context.

The physical device comprises a sensor device comprising at least one of an IR sensor, a smoke sensor, a temperature sensor and a gas sensor; and an in-home device comprising at least one of a microphone, a closed circuit TV, a refrigerator, a TV, a washing machine, a heater, and a gas valve circuit breaker.

The step of generating a hybrid virtual device comprises assigning ID to the hybrid virtual device; and generating virtual device profile information comprising ID of the hybrid virtual device and analyzed physical device configuration information.

The step of reasoning in-home context comprises reasoning in-home context using sensing information or state information received from the physical device.

The virtual home service apparatus generates a single virtual device corresponding one-to-one to the physical device, a hybrid virtual device composed with a plurality of physical devices, a hybrid virtual device composed with a plurality of virtual devices or a hybrid virtual device composed with physical devices and virtual devices.

The present invention allows providing a smart home system combined with a home network technology and a context recognition technology on a virtual space.

The present invention also allows providing user-specific virtual home services by generating virtual devices corresponding to a plurality of actual in-home physical devices by reflecting user's intention.

### BRIEF DESCRIPTION OF THE DRAWINGS

FIG. 1 is a schematic view illustrating configuration of a virtual home service apparatus.

FIG. 2 is a flowchart illustrating a virtual home service method from a virtual home service apparatus.

FIG. 3 is an exemplary view of a hybrid virtual device.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted.

When one element is described as being “connected” or “accessed” to another element, it shall be construed as being connected or accessed to the other element directly but also as possibly having another element in between.

The present invention will be described below in more detail with reference to the accompanying drawings, in which those components are rendered the same reference number that are the same or are in correspondence, regardless of the figure number, and redundant explanations are omitted.

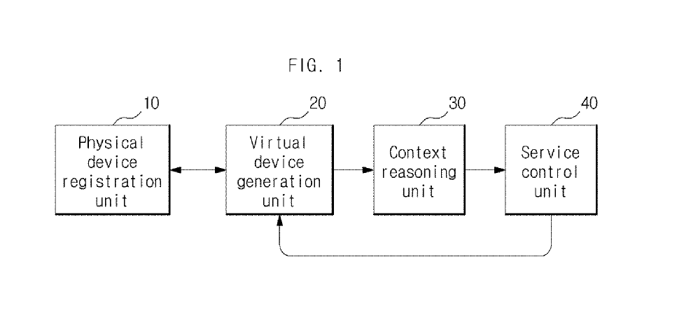

FIG. 1 is a schematic view illustrating configuration of a virtual home service apparatus.

Referring to FIG. 1, a virtual home service apparatus comprises a physical device registration unit 10, a virtual device generation unit 20, a context reasoning unit 30 and a service control unit 40.

The physical device registration unit 10 registers or deletes physical devices present in home and controls the registered physical devices.

For example, the physical device may comprise a sensor device including an IR sensor, a smoke sensor, a temperature sensor, a gas sensor and the like; and an in-home device including an actuator such as a microphone, a CCTV, a refrigerator, a TV, a washing machine, a heater, a gas valve circuit breaker and the like. The physical device registration unit 10, when profile information of physical devices is received from a physical device, may assign a unique ID to the corresponding physical device and transmit the assigned profile information to the virtual device generation unit 20. The physical device registration unit 10 may also transmit sensing information or state information received according to a Kind of physical devices to the virtual device generation unit 20 and generate control data for the corresponding physical device to transmit it to the corresponding physical device when a physical device control command is received from the virtual device generation unit 20.

For example, the profile information of the physical device may include a physical device ID, a kind, a model number, a vendor, a serial number, a function, an operation mode, position, an operating range as shown in Table 1.

TABLE 1

| Element | Description |
|---|---|
| ID | Physical device ID |
| Kind | Kind of physical devices (sensor, home |
| | appliances, actuator, etc.) |
| Model number | Physical device model number |
| Vendor | Physical device vendor |
| Serial number | Physical device serial number |
| Function | Physical device function(home appliances |
| | have complicate function information) |
| Mode | Physical device operation mode |
| Position | Position information of a physical device |
| Operating range | Operating range information in case of a sensor |

For example, in case of that a physical device is a sensor device, sensing information may be represented as shown in Table 2 according to a kind of a sensor device.

TABLE 2

| Kind of a sensor | Sensing information |
|---|---|
| Smoke sensor | Detected, Not detected |
| Gas sensor | Detected, Not detected or Gas concentration |
| Temperature sensor | −10° C.~50° C. |
| IR sensor | Detected, Not detected |

For example, state information of a physical device may be information provided from home appliances, lighting controllers, and gas valve circuit breakers, etc. In case of that the physical device is a refrigerator, state information may be state of refrigerator door (Opened/Closed), current temperature of fridge or freezer, and set temperature, etc. and in case of a gas valve circuit breaker, it may be state of gas valve (Opened/Closed).

The virtual device generation unit 20 generates a virtual device using the registered physical device. Particularly, the virtual device generation unit 20 may generate a hybrid virtual device including a plurality of physical devices according to input of a user's virtual device generation command or generate a single virtual device corresponding one-to-one to the physical device according to input of profile information of the physical devices.

For example, the virtual device generation unit 20 may generate a single virtual device corresponding one-to-one to the physical device by receiving profile information of physical devices from the physical device registration unit 10 and generate an ID-assigned hybrid virtual device according to input of a user's virtual device generation command including physical device configuration information of hybrid virtual devices.

For example, the virtual device generation unit 20 may generate profile information of a virtual device as shown in the following Table 3.

TABLE 3

| Element | Description |
|---|---|
| ID | Virtual device ID |
| Type | Virtual device type(Basic or Hybrid) |
| Number of physical | Description of the number of physical devices |
| devices | |
| Physical device | Description of a physical device ID |
| ID1, . . . N | |
| Physical device | Description of attribute setting information of a |
| attribute1, . . . N | physical device IDn |
| Number of a virtual | Description of the number of virtual devices |
| device | |
| virtual device | Description of a virtual device ID |
| ID1, . . . N | |
| virtual device | Description of attribute setting information |
| attribute1, . . . N | of a virtual device IDn |
| Number of a hybrid | Description of the number of hybrid virtual device |
| virtual device | |
| Hybrid virtual device | Description of a hybrid virtual device ID |
| ID1, . . . N | |
| Hybrid virtual device | Description of attribute setting information |
| attribute1, . . . N | of a hybrid virtual device IDn |

The virtual device generation unit 20 may have a part or whole of the physical devices and generate a single virtual device corresponding one-to-one to the physical device, a hybrid virtual device composed with a plurality of physical devices, a hybrid virtual device composed with a plurality of virtual devices or a hybrid virtual device composed with physical devices and virtual devices.

The virtual device generation unit 20 may perform registering or deleting profile information of the generated virtual device, managing history, treating sensing information or state information, and controlling the virtual devices, etc.

For example, the virtual device generation unit 20 may transmit, when sensing information or state information is received according to a kind of physical device from the physical device registration unit 10, the received sensing information or state information as virtual device information corresponding to the physical device to the context reasoning unit 30. The virtual device generation unit 20 may also transmit, when a virtual device control command is received from the service control unit 40, a physical device control command for the corresponding physical device to the physical device registration unit 10.

The context reasoning unit 30 may reason in-home context using the received virtual device information and transmit the reasoned result to the service control unit 40. For example, when virtual devices are composed with a heater and a temperature sensor installed in a master bedroom as physical devices, the context reasoning unit 30 may determine if current temperature is less than, higher than or equal to set temperature by comparing the set temperature set for the heater with the current temperature in the master bedroom measured by the temperature sensor.

The service control unit 40 may generate a virtual device control command according to the reasoned result to transmit to the virtual device generation unit 20. For example, when virtual devices are composed with a heater and a temperature sensor installed in a master bedroom as physical device, the service control unit 40 may generate a virtual device control command to or not to operate the heater to transmit to the virtual device generation unit 20 according to the result determined if current temperature is less than, higher than or equal to set temperature.

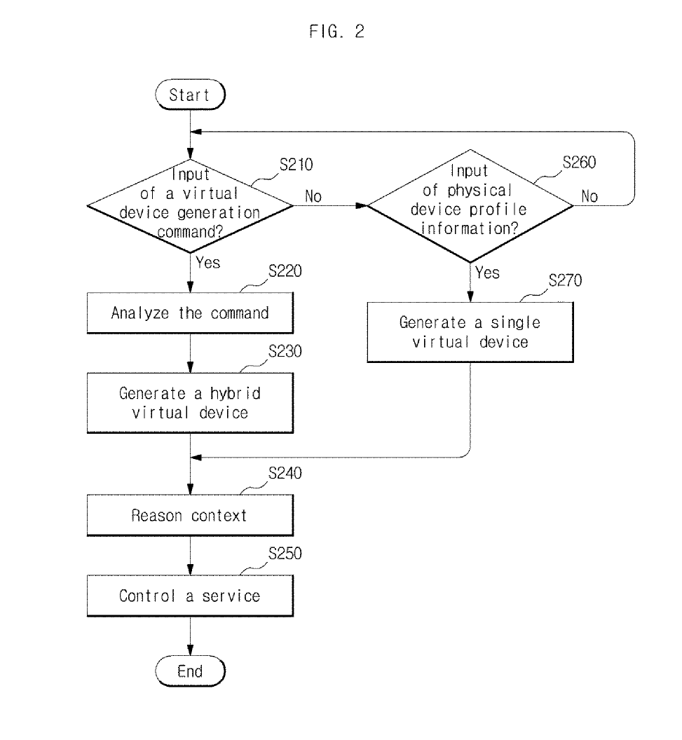

FIG. 2 is a flowchart illustrating a virtual home service method from a virtual home service apparatus.

In S210, the virtual home service apparatus determines if a virtual device generation command is inputted or not. Here, the virtual device generation command includes physical device configuration information of hybrid virtual devices set by a user. For example, the physical device configuration information of hybrid virtual devices may include a physical device ID1, attribute information of the physical device ID1, a physical device ID2 and an operation mode of the physical device ID2, etc.

In S220, the virtual home service apparatus, when a virtual device generation command is inputted, analyzes the virtual device generation command. For example, the virtual home service apparatus analyzes physical device configuration information included in the virtual device generation command in order to generate a hybrid virtual device.

In S230, the virtual home service apparatus generates a hybrid virtual device according to the analyzed result of the virtual device generation command. For example, the virtual home service apparatus assigns ID for the hybrid virtual device and generates virtual device profile information including the hybrid virtual device ID and the analyzed physical device configuration information.

In S240, the virtual home service apparatus reasons in-home context using the virtual device information according to the generation of the virtual device. For example, the virtual home service apparatus may, when virtual devices composed with a heater and a temperature sensor installed in a master bedroom as physical devices, determine if current temperature is less than, higher than or equal to set temperature by comparing the set temperature set for the heater with the current temperature in the master bedroom measured by the temperature sensor.

In S250, the virtual home service apparatus generates a virtual device control command according to the reasoned result to control a virtual home service. For example, the virtual home service apparatus may, when virtual devices composed with a heater and a temperature sensor installed in a master bedroom as physical devices, generate a virtual device control command to or not to operate the heater according to the result determined if current temperature is less than, higher than or equal to set temperature.

In S260, the virtual home service apparatus, when a virtual device generation command is not inputted, determines if physical device profile information is inputted or not.

In S270, the virtual home service apparatus, when physical device profile information is inputted, generates a single virtual device corresponding one-to-one to the physical device using the physical device profile information and then proceeds to S240. For example, the virtual home service apparatus, when 10 physical devices are installed in home and 10 physical device profile information are received, may generate 10 single virtual devices.

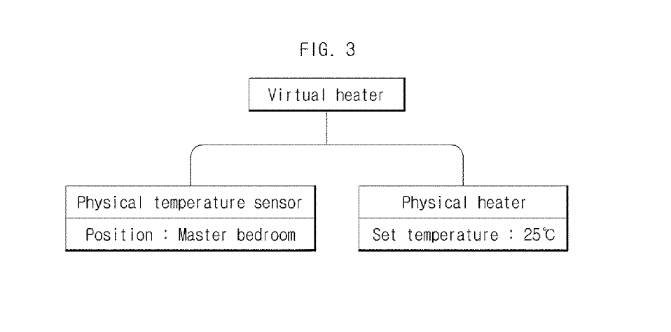

FIG. 3 is an exemplary view of a hybrid virtual device.

Referring to FIG. 3, a virtual heater generated as a hybrid virtual device may include a physical temperature sensor and a physical heater. It may be assumed that the physical temperature sensor is installed in a master bedroom and set temperature of the physical heater is 25° C.

A general heater controls heating using temperature information of an atmospheric temperature sensor built in a heater controller or a heating-water temperature sensor installed in a heater body. When a user wants heating mainly for a master bedroom, a virtual heater combined with a physical temperature sensor built in the master bedroom and a physical heater may be generated as shown in FIG. 3. Here, the virtual heater may obtain temperature information using the temperature sensor in the master bedroom by clearing temperature-related sensing information from attribute information of the physical heater. The virtual home service apparatus may reason context using state information and sensing information (operation information of the physical heater and temperature information measured by the physical temperature sensor) of the generated virtual heater. For example, when the physical heater is operating, set temperature is 25° C., and current temperature is 28° C., the virtual home service apparatus reasons context as that the current temperature is higher than the set temperature and controls to stop the physical heater operation.

The virtual home service method according to an embodiment of the present invention can be recorded in a storage medium by being implemented in a program instruction form which is able to be performed through various data processing means. The storage medium can include program instructions, data files, data structures and the like alone or combinations thereof.

The program instruction recorded in the storage medium may be specially designed and configured for the present invention or be available and well known to those who are skilled in the software field. An example of the storage medium may include magnetic media such as a hard disk, a floppy disk and a magnetic tape; magneto-optical media such as a CD-ROM and a DVD; magneto-optical media such as a floptical disk; and hardware devices such as a ROM, a RAM, a flash memory and the like which are configured to store and perform program instructions. The above-mentioned medium may be a transmission medium such as optical or metallic lines and waveguides including a carrier which transmits signals to assign program instructions, data structures and the like. An example of the program instruction may include not only machine-language codes which are made by a compiler but also high-level language codes which are executable by a device such as a computer processing information electronically by using an interpreter and the like.

The hardware device above mentioned may be configured to perform operations of the present invention as one or more software modules and vice versa.

### DESCRIPTION OF REFERENCE NUMERALS

10: physical device registration unit
20: virtual device generation unit
30: context reasoning unit
40: service control unit

What is claimed is:

1. A virtual home service apparatus comprising:
a physical device registration unit registering or deleting physical devices present in home and controlling the registered physical devices;
a virtual device generation unit generating virtual devices using the registered physical devices;
a context reasoning unit reasoning in-home context using information of the generated virtual devices; and
a service control unit generating a virtual device control command according to the result of the reasoned in-home context and delivering the result to the virtual device generation unit,
wherein the virtual device generation unit generates hybrid virtual devices comprising a plurality of physical devices according to input of a user's virtual device generation command including physical device configuration information of the hybrid virtual devices or generates a single virtual device corresponding one-to-one to the physical device according to input of profile information of the physical device.

2. The virtual home service apparatus of claim 1, wherein the physical device comprises a sensor device comprising at least one of an IR sensor, a smoke sensor, a temperature sensor, and a gas sensor; and an in-home device comprising at least one of a microphone, a closed circuit TV(CCTV), a refrigerator, a TV, a washing machine, a heater, and a gas valve circuit breaker.

3. The virtual home service apparatus of claim 1, wherein the physical device registration unit transmits sensing information or state information received from the physical device to the virtual device generation unit, and generates, when a physical device control command is received from the virtual device generation unit, control data for a corresponding physical device and transmits the result to the corresponding physical device.

4. The virtual home service apparatus of claim 1, wherein the virtual device generation unit generates a single virtual device corresponding one-to-one to the physical device by receiving profile information of the physical device from the physical device registration unit to or generates a ID-assigned hybrid virtual device according to input of a user's virtual device generation command including physical device configuration information of the hybrid virtual device.

5. The virtual home service apparatus of claim 1, wherein the virtual device generation unit generates a single virtual device corresponding one-to-one to the physical device, a hybrid virtual device composed with a plurality of physical devices, a hybrid virtual device composed with a plurality of virtual devices or a hybrid virtual device composed with physical devices and virtual devices.

6. The virtual home service apparatus of claim 1, wherein the virtual device generation unit, when sensing information or state information received from the physical device is received from the physical device registration unit, transmits the received the received sensing information or state information as virtual device information corresponding to the physical device to the context reasoning unit, and transmits, when the virtual device control command is received from the service control unit, a physical device control command for the corresponding physical device to the physical device registration unit.

7. A virtual home service method comprising:
being inputted with a user's virtual device generation command comprising physical device configuration information of hybrid virtual devices;
generating the hybrid virtual device comprising a plurality of physical devices by analyzing the virtual device generation command;
generating a single virtual device corresponding one-to-one to the physical device when the virtual device generation command is not inputted but profile information of physical devices is;
reasoning in-home context using virtual device information according to the generation of the virtual device; and
controlling a virtual home service by generating a virtual device control command according to the result from the reasoning in-home context.

8. The virtual home service method of claim 7, wherein the physical device comprises a sensor device comprising at least one of an IR sensor, a smoke sensor, a temperature sensor and a gas sensor; and an in-home device comprising at least one of a microphone, a closed circuit TV, a refrigerator, a TV, a washing machine, a heater, and a gas valve circuit breaker.

9. The virtual home service method of claim 7, wherein the step of generating a hybrid virtual device comprises assigning ID to the hybrid virtual device; and generating virtual device profile information comprising ID of the hybrid virtual device and analyzed physical device configuration information.

10. The virtual home service method of claim 7, wherein the step of reasoning in-home context comprises reasoning in-home context using sensing information or state information received from the physical device.

11. The virtual home service method of claim 7, wherein the virtual home service apparatus generates a single virtual device corresponding one-to-one to the physical device, a hybrid virtual device composed with a plurality of physical devices, a hybrid virtual device composed with a plurality of virtual devices or a hybrid virtual device composed with physical devices and virtual devices.
